(19) United States
(12) Patent Application Publication
(10) Pub. No.: US 2013/0159198 A1
(43) Pub. Date: Jun. 20, 2013

(54) PROJECT MAPPER

(71) Applicants: John Cartan, Alameda, CA (US); Owen Lin, Fremont, CA (US)

(72) Inventors: John Cartan, Alameda, CA (US); Owen Lin, Fremont, CA (US)

(73) Assignee: Oracle International Corporation, Redwood Shores, CA (US)

(21) Appl. No.: 13/329,655

(22) Filed: Dec. 19, 2011

(51) Int. Cl. G06Q 10/06

(52) U.S. Cl. 705/301

(57) ABSTRACT

Embodiments of the invention provide systems and methods for providing a graphical, interactive representation of activities within a project. According to one embodiment, a method for providing a graphical, interactive map representing a project can comprise reading a description of the project. The description can define a plurality of activities in the project and one or more milestones for the project. The plurality of activities and one or more milestones can comprise elements of the map. One or more ordered lists of elements can be generated based on the description. The one or more ordered lists can be arranged in one or more levels. The map can be drawn based on the levels of ordered lists.

### BACKGROUND OF THE INVENTION

Embodiments of the present invention relate generally to methods and systems for project management and more particularly to methods and systems for providing a graphical, interactive representation of activities within a project.

Project management applications provide functions for the planning and scheduling, resource allocation, budget control, and other aspects of managing large scale projects. These applications typically provide a collaborative environment in which users can view and interact with information related to the project. For example, scheduled activities and milestones for the project can be represented in various ways including Gantt charts, PERT diagrams, etc. displayed to the users of the project management application.

In order to plan and manage a large project it is essential to understand that project's structure in depth, including the duration of each activity and its dependencies on other activities. Unfortunately, it is very difficult to visualize large projects. Techniques such as Gantt charts and PERT network diagrams do not scale well and are of limited value. Currently, users of project management applications often either painstakingly tape together printed, mural-sized charts on a weekly basis or rely primarily on spreadsheets. These techniques are frustrating, time-consuming, and error-prone. Hence, there is a need for improved methods and systems for representing activities within a project.

### BRIEF SUMMARY OF THE INVENTION

Embodiments of the invention provide systems and methods for providing a graphical, interactive representation of activities within a project. According to one embodiment, a method for providing a graphical, interactive map representing a project can comprise reading a description of the project. The description can define a plurality of activities in the project and one or more milestones for the project. The plurality of activities and one or more milestones can comprise elements of the map. One or more ordered lists of elements can be generated based on the description. The one or more ordered lists can be arranged in one or more levels. The map can be drawn based on the levels of ordered lists.

Generating one or more ordered lists of elements can comprise determining for each element of the map and based on the description, a predecessor element, a start time, and an end time. A flexible width can be determined for each of a plurality of time periods. The plurality of time periods together can include the start times and end times of the elements of the map. A position on the map and a width of a graphical representation of each element of the map can be determined and a terminus for each element of the map can be identified. One or more ordered lists of successor elements can be created based on the identified terminus of each element. A level within the map can be determined for each of the one or more ordered lists. A float limit can be identified for each level. In some cases, a first level within the map and a second level within the map can be collapsed or combined if the first level and the second level do not overlap.

Determining for each element of the map a predecessor element, a start time, and an end time can comprise creating a table mapping an element identifier to a sequence number for each element of the map. A determination can be made as to whether at least one starting element is represented in the table. In response to determining at least one starting element is represented in the table a predecessor, start time and end time can be set for each starting element and any elements other than starting elements.

Determining the flexible width for each of the plurality of time periods can comprise determining a width of each of a plurality of periods. Each period can include one or more elements. Determining the width of each of the plurality of periods can be based on a duration of the activities in the period. The period width can be expanded for any period including at least one milestone. A position in the map can be determined for each of the plurality of periods based on a sum of period widths for periods prior to each period.

Determining the position on the map and the width of the graphical representation of each element can comprise setting margins between sequential elements to a predetermined amount. Position values can be set for each activity based on start time, end time, and margin for each activity. Position values can be set for each milestone based on start time and a predetermined milestone width. Positions of predecessor elements of milestones can be adjusted based on the positions of the milestones and the predecessors.

Identifying the terminus for each element can comprise identifying an element with a latest end time. The element with the latest end time can be assigned as a terminus of itself. A terminus of preceding elements in the same sequence can be assigned based on the sequence. Identifying an element with a latest end time, assigning the element with the latest end time as a terminus of itself, and assigning a terminus of preceding elements in the same sequence based on the sequence can be repeated until all of the elements are assigned a terminus.

Creating the one or more ordered lists of successor elements can comprise determining whether an element is an initial element in a sequence. In response to determining the element is the initial element in the sequence, the successor list can be left empty. In response to determining the element is not the initial element in the sequence, the element can be added to the ordered list for the sequence based on the terminus of the element and the termini of other elements in the ordered list. Determining whether an element is an initial element in a sequence and leaving the successor list empty or adding the element to the ordered list for the sequence can be repeated until all elements are added to an ordered list.

Determining the level within the map for each of the one or more ordered lists can comprise identifying an element with a latest end time. The identified element can be set as a terminus of a longest remaining sequence. Immediate predecessors can be added to the longest remaining sequence until an initial element is found. Identifying an element with a latest end time, setting the identified element as a terminus of a longest remaining sequence, and adding immediate predecessors to the longest remaining sequence can be repeated until an initial element is found until all elements are assigned.

Identifying the float limit for each level can comprise setting a float limit for a terminus of each ordered list based on an earliest start time for a predecessor element in the ordered list. A number of levels assigned can be identified based on a number of ordered lists. A determination can be made as to whether the number of levels exceeds a predetermined threshold. In response to determining the number of levels exceeds the predetermined threshold, edge positions can be set for each level, a first level within the map and a second level within the map can be collapsed if the float limit for the first level is less than a start time of an initial element of the second level and a predetermined margin, and a space between levels can be adjusted.

Drawing the map can comprise drawing a time scale based on the plurality of time periods. The elements can be drawn based on the ordered lists. The determined float limits can be drawn based on the time scale. Successor lines between the elements can be drawn based on the ordered lists.

According to another embodiment, a computer-readable memory can have stored thereon a sequence of instructions which, when executed by a processor, causes the processor to provide a graphical, interactive map representing a project by reading a description of the project. The description can define a plurality of activities in the project and one or more milestones for the project. The plurality of activities and one or more milestones can comprise elements of the map. For each element of the map and based on the description, a predecessor element, a start time, and an end time can be determined. A flexible width can be determined for each of a plurality of time periods. The plurality of time periods together can include the start times and end times of the elements of the map. A position on the map and a width of a graphical representation of each element of the map can be determined and a terminus can be identified for each element of the map. One or more ordered lists of successor elements can be created based on the identified terminus of each element. A level within the map can be determined for each of the one or more ordered lists and a float limit can be identified for each level. In some cases, a first level within the map and a second level within the map can be collapsed if the first level and the second level do not overlap. The map can be drawn based on the levels of ordered lists.

According to yet another embodiment, a system can comprise a processor and a memory communicatively coupled with and readable by the processor. The memory can have stored therein a sequence of instructions which, when executed by the processor, cause the processor to provide a graphical, interactive map representing a project by reading a description of the project. The description can define a plurality of activities in the project and one or more milestones for the project. The plurality of activities and one or more milestones can comprise elements of the map. One or more ordered lists of elements can be generated based on the description. The one or more ordered lists can be arranged in one or more levels and the map can be drawn based on the levels of ordered lists

### BRIEF DESCRIPTION OF THE DRAWINGS

FIG. 1 is a block diagram illustrating components of an exemplary operating environment in which various embodiments of the present invention may be implemented.

FIG. 2 is a block diagram illustrating an exemplary computer system in which embodiments of the present invention may be implemented.

FIG. 3 is a block diagram illustrating, at a high-level, functional components of a system for implementing a project mapper according to one embodiment of the present invention.

FIG. 4 is a block diagram illustrating a representation of an exemplary project map according to one embodiment of the present invention.

FIG. 5 is a flowchart illustrating a process for generating a project map according to one embodiment of the present invention.

FIG. 6 is a flowchart illustrating a process for determining predecessors, start times, and end times for activities of a project according to one embodiment of the present invention.

FIG. 7 is a flowchart illustrating a process for determining widths of map elements according to one embodiment of the present invention.

FIG. 8 is a flowchart illustrating a process for determining positions and widths of map elements according to one embodiment of the present invention.

FIG. 9 is a flowchart illustrating a process for determining termini of map elements according to one embodiment of the present invention.

FIG. 10 is a flowchart illustrating a process for creating ordered lists of successors of map elements according to one embodiment of the present invention.

FIG. 11 is a flowchart illustrating a process for determining sequence levels of map elements according to one embodiment of the present invention.

FIG. 12 is a flowchart illustrating a process for determining float limits and collapse levels of map elements according to one embodiment of the present invention.

FIG. 13 is a flowchart illustrating a process for drawing a project map according to one embodiment of the present invention.

FIG. 14 is a representation of an exemplary user interface for a project map according to one embodiment of the present invention.

### DETAILED DESCRIPTION OF THE INVENTION

In the following description, for the purposes of explanation, numerous specific details are set forth in order to provide a thorough understanding of various embodiments of the present invention. It will be apparent, however, to one skilled in the art that embodiments of the present invention may be practiced without some of these specific details. In other instances, well-known structures and devices are shown in block diagram form.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “machine-readable medium” includes, but is not limited to portable or fixed storage devices, optical storage devices, wireless channels and various other mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Embodiments of the invention provide systems and methods for providing a graphical, interactive representation of activities within a project. More specifically, embodiments of the present invention provide a project mapper that can provide a visualization, i.e., a map, of activities and milestones in a project. This map can be delivered as a touchable, zoomable, interactive representation for display, for example on a hand-held tablet or other portable device. Unlike PERT charts, which are zero-dimensional nodes arranged arbitrarily in space, and Gantt charts which are one-dimensional bars stacked in random order, project maps as described herein can be fully two dimensional in that group width can show length of critical paths and group height can show amounts of concurrent activity. Sequential activities can be arranged sequentially in a way that clarifies both critical and the sub-critical paths harder to see using earlier methods. According to one embodiment, a “flexible timeline” technique can be used to include zero-duration milestone events that take up space but not time and to make visual elements of different sizes more manageable. Activities can be represented as boxes designed to be nested and used as a canvas to overlay additional analytics like progress and resource allocation.

The project map can be comprised of an overview map plus distinct maps for each collapsed group, a system that provides meaningful views at any point regardless of the depth of the project's work breakdown structure. A viewer interface for presenting the map can allow panning, zooming, and drilling to sub-maps in an intuitive way. A full project timeline and moving reference box can be used to prevent users from becoming disoriented as they explore a large project. Additional information can be displayed as map elements become larger during zooming. Multiple modes, including a progress mode and a resources mode can provide additional information displays against the context of the map. A pullout list and project inspector enables searching and filtering.

The project mapper provides a significantly better visualization of a project, regardless of project size. Users can understand duration and dependency relationships much more quickly and easily than was earlier possible. The map provides a consistent context against which to display other information in a meaningful way. Subtle problems and hidden patterns are made obvious in a way not possible before. Various additional details of embodiments of the present invention will be described below with reference to the figures.

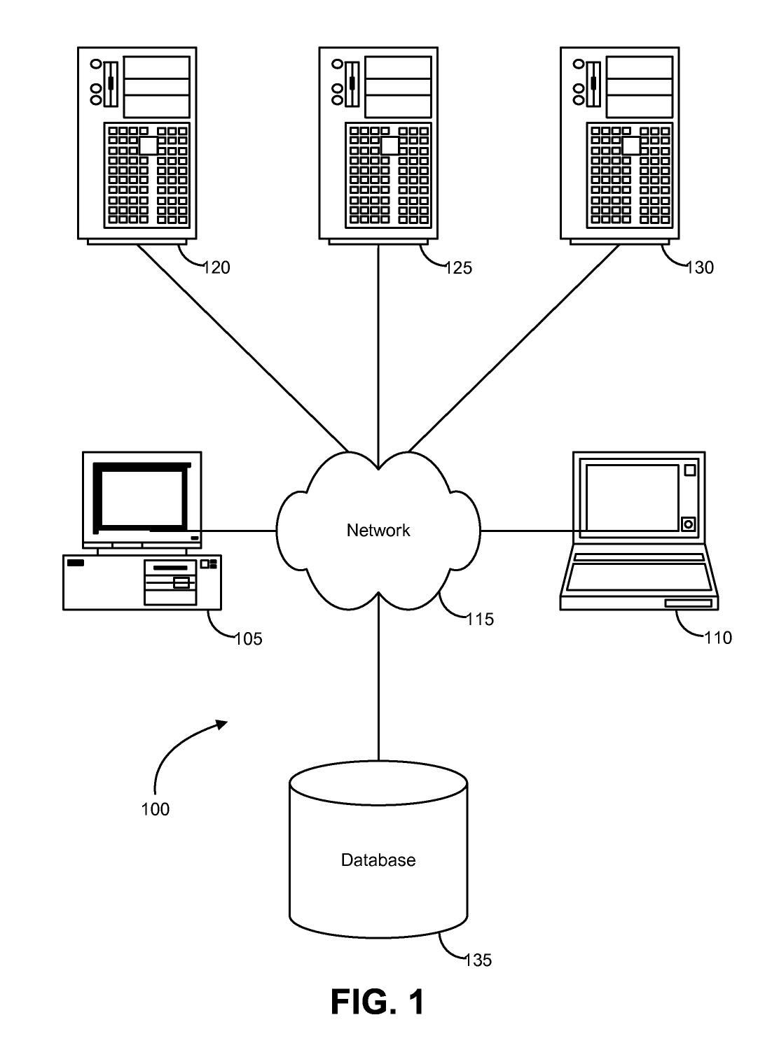

FIG. 1 is a block diagram illustrating components of an exemplary operating environment in which various embodiments of the present invention may be implemented. The system 100 can include one or more user computers 105, 110, which may be used to operate a client, whether a dedicate application, web browser, etc. The user computers 105, 110 can be general purpose personal computers (including, merely by way of example, personal computers and/or laptop computers running various versions of Microsoft Corp.'s Windows and/or Apple Corp.'s Macintosh operating systems) and/or workstation computers running any of a variety of commercially-available UNIX or UNIX-like operating systems (including without limitation, the variety of GNU/Linux operating systems). These user computers 105, 110 may also have any of a variety of applications, including one or more development systems, database client and/or server applications, and web browser applications. Alternatively, the user computers 105, 110 may be any other electronic device, such as a thin-client computer, Internet-enabled mobile telephone, and/or personal digital assistant, capable of communicating via a network (e.g., the network 115 described below) and/or displaying and navigating web pages or other types of electronic documents. Although the exemplary system 100 is shown with two user computers, any number of user computers may be supported.

In some embodiments, the system 100 may also include a network 115. The network may can be any type of network familiar to those skilled in the art that can support data communications using any of a variety of commercially-available protocols, including without limitation TCP/IP, SNA, IPX, AppleTalk, and the like. Merely by way of example, the network 115 maybe a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, the Bluetooth protocol known in the art, and/or any other wireless protocol); and/or any combination of these and/or other networks such as GSM, GPRS, EDGE, UMTS, 3G, 2.5 G, CDMA, CDMA2000, WCDMA, EVDO etc.

The system may also include one or more server computers 120, 125, 130 which can be general purpose computers and/or specialized server computers (including, merely by way of example, PC servers, UNIX servers, mid-range servers, mainframe computers rack-mounted servers, etc.). One or more of the servers (e.g., 130) may be dedicated to running applications, such as a business application, a web server, application server, etc. Such servers may be used to process requests from user computers 105, 110. The applications can also include any number of applications for controlling access to resources of the servers 120, 125, 130.

The web server can be running an operating system including any of those discussed above, as well as any commercially-available server operating systems. The web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers 105, 110. As one example, a server may execute one or more web applications. The web application may be implemented as one or more scripts or programs written in any programming language, such as Java™, C, C# or C++, and/or any scripting language, such as Perl, Python, or TCL, as well as combinations of any programming/scripting languages. The server(s) may also include database servers, including without limitation those commercially available from Oracle®, Microsoft®, Sybase®, IBM® and the like, which can process requests from database clients running on a user computer 105, 110.

In some embodiments, an application server may create web pages dynamically for displaying on an end-user (client) system. The web pages created by the web application server may be forwarded to a user computer 105 via a web server. Similarly, the web server can receive web page requests and/or input data from a user computer and can forward the web page requests and/or input data to an application and/or a database server. Those skilled in the art will recognize that the functions described with respect to various types of servers may be performed by a single server and/or a plurality of specialized servers, depending on implementation-specific needs and parameters.

The system 100 may also include one or more databases 135. The database(s) 135 may reside in a variety of locations. By way of example, a database 135 may reside on a storage medium local to (and/or resident in) one or more of the computers 105, 110, 115, 125, 130. Alternatively, it may be remote from any or all of the computers 105, 110, 115, 125, 130, and/or in communication (e.g., via the network 120) with one or more of these. In a particular set of embodiments, the database 135 may reside in a storage-area network (“SAN”) familiar to those skilled in the art. Similarly, any necessary files for performing the functions attributed to the computers 105, 110, 115, 125, 130 may be stored locally on the respective computer and/or remotely, as appropriate. In one set of embodiments, the database 135 may be a relational database, such as Oracle 10g, that is adapted to store, update, and retrieve data in response to SQL-formatted commands.

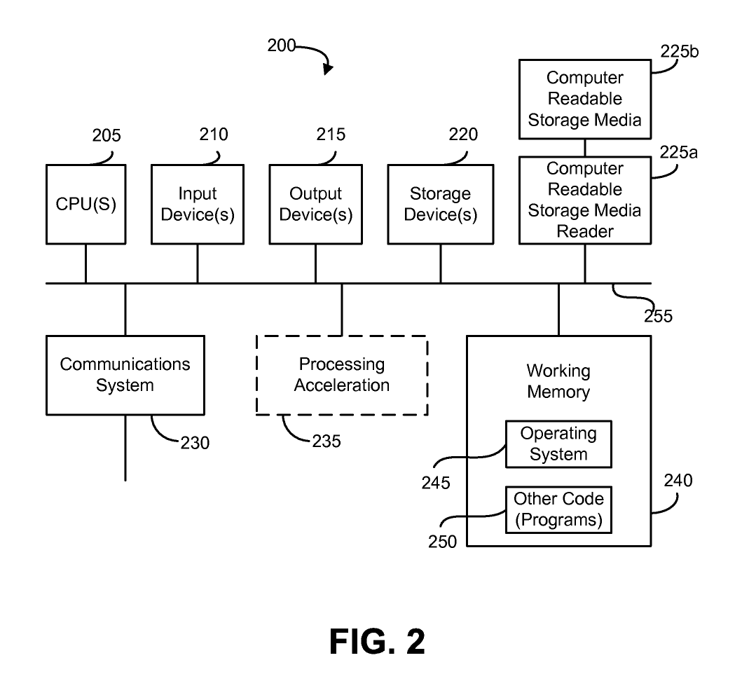

FIG. 2 illustrates an exemplary computer system 200, in which various embodiments of the present invention may be implemented. The system 200 may be used to implement any of the computer systems described above. The computer system 200 is shown comprising hardware elements that may be electrically coupled via a bus 255. The hardware elements may include one or more central processing units (CPUs) 205, one or more input devices 210 (e.g., a mouse, a keyboard, etc.), and one or more output devices 215 (e.g., a display device, a printer, etc.). The computer system 200 may also include one or more storage device 220. By way of example, storage device(s) 220 may be disk drives, optical storage devices, solid-state storage device such as a random access memory (“RAM”) and/or a read-only memory (“ROM”), which can be programmable, flash-updateable and/or the like.

The computer system 200 may additionally include a computer-readable storage media reader 225a, a communications system 230 (e.g., a modem, a network card (wireless or wired), an infra-red communication device, etc.), and working memory 240, which may include RAM and ROM devices as described above. In some embodiments, the computer system 200 may also include a processing acceleration unit 235, which can include a DSP, a special-purpose processor and/or the like.

The computer-readable storage media reader 225a can further be connected to a computer-readable storage medium 225b, together (and, optionally, in combination with storage device(s) 220) comprehensively representing remote, local, fixed, and/or removable storage devices plus storage media for temporarily and/or more permanently containing computer-readable information. The communications system 230 may permit data to be exchanged with the network 220 and/or any other computer described above with respect to the system 200.

The computer system 200 may also comprise software elements, shown as being currently located within a working memory 240, including an operating system 245 and/or other code 250, such as an application program (which may be a client application, web browser, mid-tier application, RDBMS, etc.). It should be appreciated that alternate embodiments of a computer system 200 may have numerous variations from that described above. For example, customized hardware might also be used and/or particular elements might be implemented in hardware, software (including portable software, such as applets), or both. Further, connection to other computing devices such as network input/output devices may be employed. Software of computer system 200 may include code 250 for implementing embodiments of the present invention as described herein.

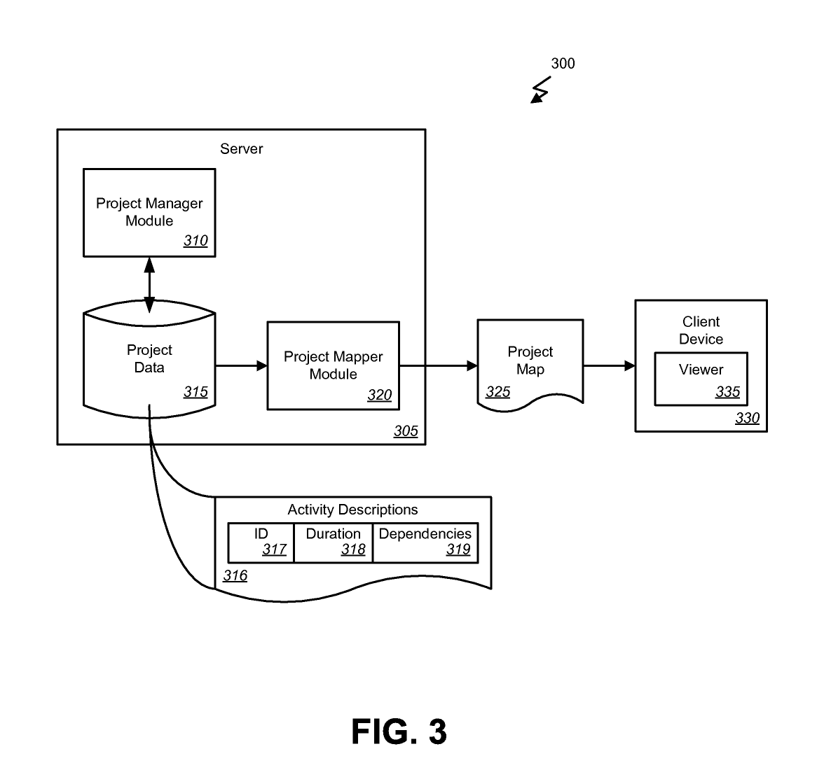

FIG. 3 is a block diagram illustrating, at a high-level, functional components of a system for implementing a project mapper according to one embodiment of the present invention. In this example, the system 300 includes a server 305 or other system executing a project manager module 310 or application. The project manager module 310 can comprise any of a variety of different applications for defining, managing, and accessing project data 315 defining various activities and milestones of a project.

According to one embodiment, the server 305 can also include a project mapper module 320 having access to the project data 315. It should be noted that, while illustrated here as separate from the project manager module 310 for the sake of simplicity and clarity, the project mapper module 320 may, depending upon the exact implementation, be part of the project manager module 310 or application or another application or module of the server 305 or even another computer system. Additionally, it should be understood that the project mapper module 310 can be implemented on another device rather than on the server 305. For example, the project mapper module 310 can be implemented on a client device 330 such as a personal computer, tablet, cell phone or other mobile device, etc. that reads project activity descriptions 316 from the server 305 and then performs the various processes described below for generating and drawing or rendering a project map locally, on that device.

Generally speaking and regardless of where it is executing, the project mapper module 320 can execute an algorithm that can draw a project map 325 for an arbitrarily complex group such as activities and milestones represented in the project data 315. More specifically, the project map 325 can be generated from a description 316 of the project stored in the project data 315 as a property list. According to one embodiment, each activity and milestone of the project can be represented in the description 316 as:
An ID number 317 derived from the activity's or milestone's line number in its overall Work Breakdown Structure (WBS); the example maps described below use these numbers as labels.
The activity's duration 318, e.g., in days. Milestones can have a duration of 0.
The remaining item or items 319 can include the ID number(s) that activity is dependent on. If no other items are present, that activity can be considered an initial activity that starts when the group starts.

For example, Table 1 below shows a set of 40 activities and milestones described in a property list. In this example, the activities have up to 5 predecessors with one initial activity (activity number 4):

TABLE 1

| Activity | ID | Duration | P1 | P2 | P3 | P4 | P5 |
|---|---|---|---|---|---|---|---|
| 1 | 61 | 6 | 66 | | | | |
| 2 | 64 | 17 | 66 | | | | |
| 3 | 65 | 7 | 81 | | | | |
| 4 | 66 | 5 | | | | | |
| 5 | 67 | 15 | 73 | | | | |
| 6 | 68 | 15 | 73 | | | | |
| 7 | 69 | 15 | 56 | 73 | | | |
| 8 | 70 | 2 | 79 | | | | |
| 9 | 71 | 5 | 80 | | | | |
| 10 | 72 | 1 | 70 | 71 | | | |
| 11 | 73 | 12 | 109 | | | | |
| 12 | 74 | 8 | 75 | | | | |
| 13 | 75 | 0 | 67 | 68 | 69 | 73 | |
| 14 | 76 | 5 | 64 | | | | |
| 15 | 77 | 5 | 74 | 76 | 78 | | |
| 16 | 78 | 0 | 76 | | | | |
| 17 | 79 | 4 | 74 | 77 | | | |
| 18 | 80 | 6 | 90 | 95 | 99 | 103 | 105 |
| 19 | 81 | 10 | 74 | | | | |
| 20 | 82 | 4 | 89 | 102 | | | |
| 21 | 83 | 5 | 79 | | | | |
| 22 | 84 | 6 | 82 | | | | |
| 23 | 85 | 3 | 93 | | | | |
| 24 | 89 | 7 | 80 | 106 | | | |
| 25 | 90 | 10 | 98 | | | | |
| 26 | 93 | 7 | 65 | 74 | 81 | 94 | |
| 27 | 94 | 5 | 80 | | | | |
| 28 | 95 | 15 | 64 | 66 | | | |
| 29 | 96 | 15 | 64 | | | | |
| 30 | 97 | 15 | 64 | 66 | | | |
| 31 | 98 | 15 | 61 | | | | |
| 32 | 99 | 7 | 97 | | | | |
| 33 | 101 | 5 | 64 | | | | |
| 34 | 102 | 12 | 80 | 104 | | | |
| 35 | 103 | 10 | 64 | | | | |
| 36 | 104 | 8 | 101 | 103 | 105 | | |
| 37 | 105 | 10 | 66 | 101 | | | |
| 38 | 106 | 10 | 97 | 98 | 108 | | |
| 39 | 108 | 5 | 99 | | | | |
| 40 | 109 | 6 | 64 | | | | |

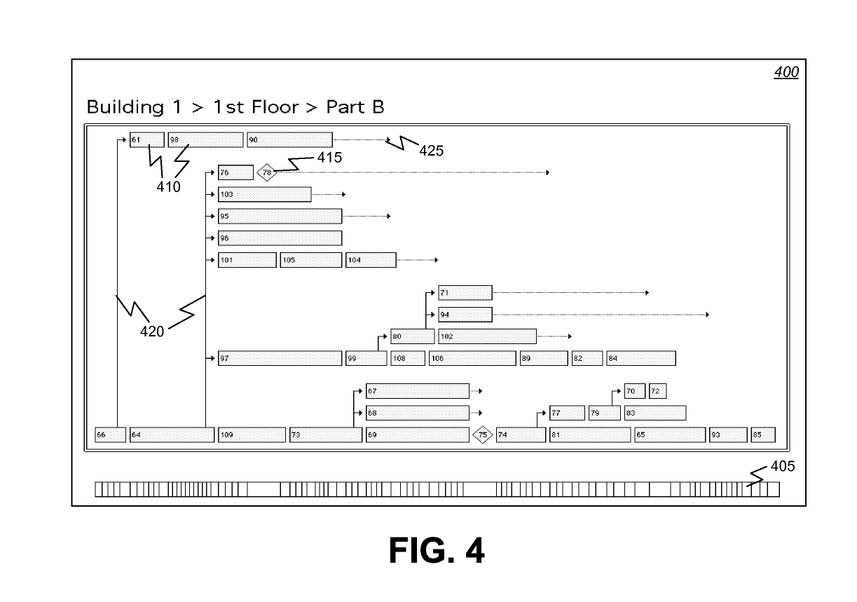

It should be noted that, for illustrative purposes, the elements, i.e., the activities and milestones, represented in this table are represented as an exemplary map in FIG. 4 which will be described in detail below.

As noted above, the project mapper module 320 can execute an algorithm that can draw a project map 325 (such as map 400 of FIG. 4) based on the description 316 (such as table 1). An exemplary algorithm for the project mapper module 320 can be outlined as:
1. determine the primary predecessor, start day, and end day for each activity
2. determine flexible day widths in pixels using a special table
3. calculate x position and pixel width of each activity box
4. find the terminus (final activity in each sequence) for each activity
5. create an ordered list of successors arranged by sequence length
6. determine which “level” or y-position each sequence will have
7. find float limits and collapse some levels to use the space efficiently
8. use this information to draw the map

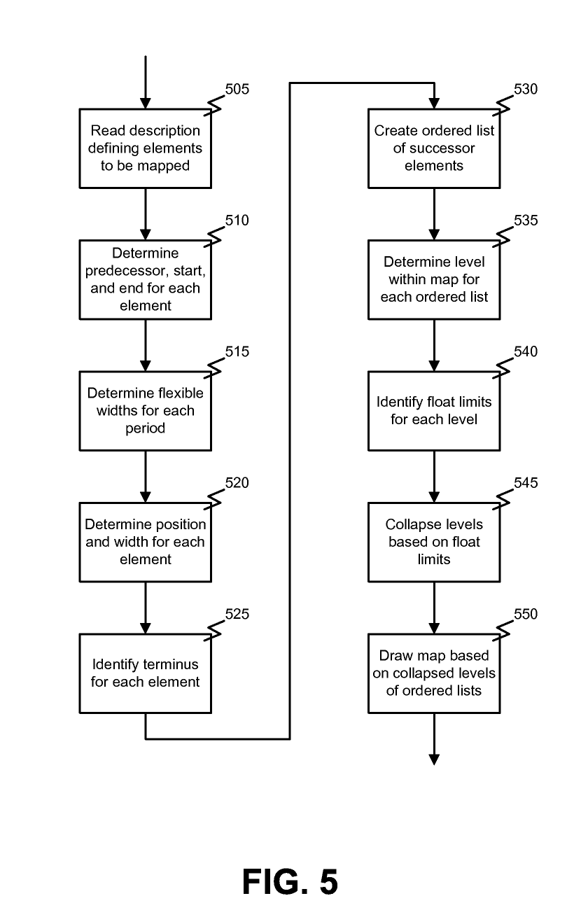

Stated another way, generating and providing a graphical, interactive map representing a project can begin with reading a description of the project. The description can define a plurality of activities in the project and one or more milestones for the project. The plurality of activities and one or more milestones can comprise elements to be presented in the map. Generally speaking, one or more ordered lists of elements, i.e., activities and milestones to be presented in the map, can be generated based on the description. The one or more ordered lists can be arranged in one or more levels and displayed in the map. More specifically, generating one or more ordered lists of elements can comprise determining for each element of the map and based on the description, a predecessor element, a start time, and an end time. A flexible width can be determined for each of a plurality of time periods. The plurality of time periods together can include or span the start times and end times of the elements of the map, i.e., represent the span of the project. Next, a position on the map and a width of a graphical representation of each element of the map can be determined. A terminus can be identified for each element of the map. One or more ordered lists of successor elements can be creating based on the identified terminus of each element. Once the ordered lists have been created, a level within the map can be determined for each of the one or more ordered lists. A float limit for each level can also be identified In some cases, a first level within the map and a second level within the map may be collapsed or combined into a single level if the first level and the second level do not overlap. Finally, the map can be drawn based on the levels of ordered lists. This algorithm and processes thereof will be described in greater detail below with reference to FIGS. 5-13.

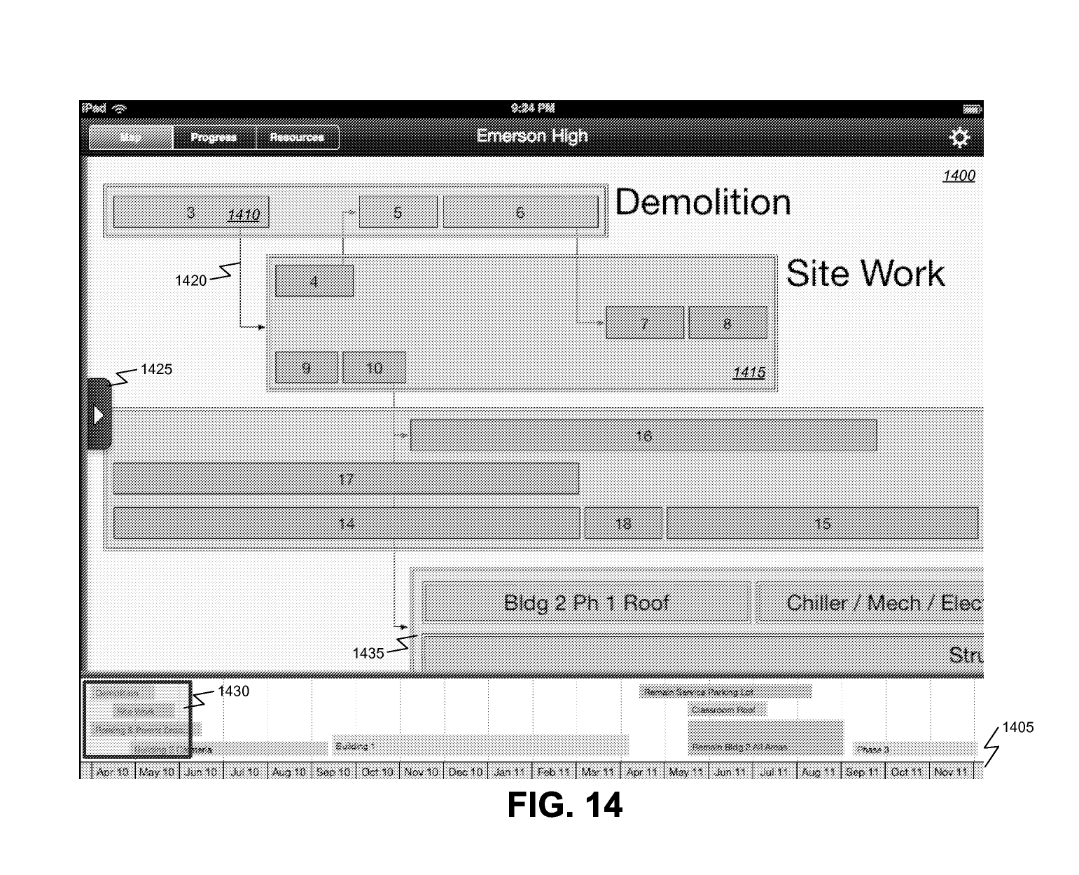

Once generated, the project map 325 can be sent to client device 330 for rendering by viewer 335. The client device 330 can comprise any of a wide variety of computing devices including but not limited to a personal computer, tablet, cell phone or other mobile device, etc. The viewer 335 can comprise an application adapted to receive and render the project map 325 for viewing on the client device 330 and for supporting interaction with the user, e.g., scrolling, zooming, selecting, receiving various other inputs, etc. An example of such an interface, as may be presented on a mobile device such as a tablet, is described in greater detail below with reference to FIG. 14.

FIG. 4 is a block diagram illustrating a representation of an exemplary project map according to one embodiment of the present invention. As noted, the map 400 illustrated here is an example of a map 400 that can be generated based on a description of activities and milestones as illustrated in Table 1 above. The map 400 can include a timeline 405 spanning the duration of the project, or the portion of the project represented in the map 400. The timeline can include a set of hash marks 406 on the timeline 405 representing various time periods. The marks 406 can be generated based on the activities and milestones represented in the map 400 as will be described in greater detail below.

Also as illustrated here, activities 410 can be represented as boxes or rectangles of varying widths depending upon or related to the duration of the particular activity. Additionally, milestones 415 can be represented, for example as a diamond of a fixed width. The project map 400 as illustrated here can be fully two dimensional in that group width, i.e., the width of a set of activities and milestones, can show length of critical paths and group height can show amounts of concurrent activity. Sequential activities can be arranged sequentially and connected by successor lines 420 in a way that clarifies both critical and the sub-critical paths harder to see using earlier methods. Activities 410 and milestones 415 represented in the map 400 can be nested in any of a number of levels and used as a canvas to overlay additional analytics like progress and resource allocation (not shown here for the sake of simplicity and clarity). Exemplary processes for generating such a map will now be described.

FIG. 5 is a flowchart illustrating a process for generating a project map according to one embodiment of the present invention. In this example, generating and providing a graphical, interactive map (such as map 400 of FIG. 4 for example) representing a project (such as may be defined in Table 1 above for example) can begin with reading 505 a description of the project. The description can define a plurality of activities in the project and one or more milestones for the project. The plurality of activities and one or more milestones can comprise elements to be presented in the map. Generally speaking, one or more ordered lists of elements, i.e., activities and milestones to be presented in the map, can be generated based on the description. The one or more ordered lists can be arranged in one or more levels and displayed in the map.

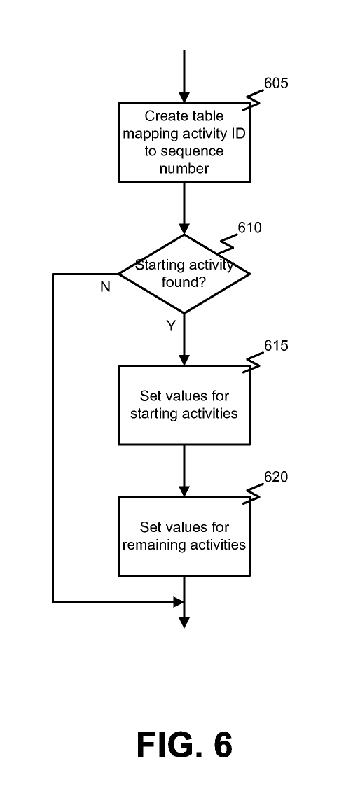

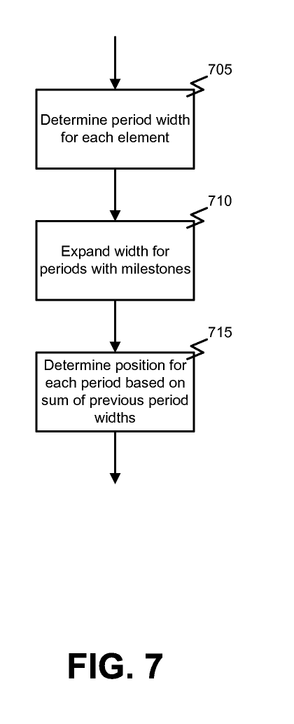

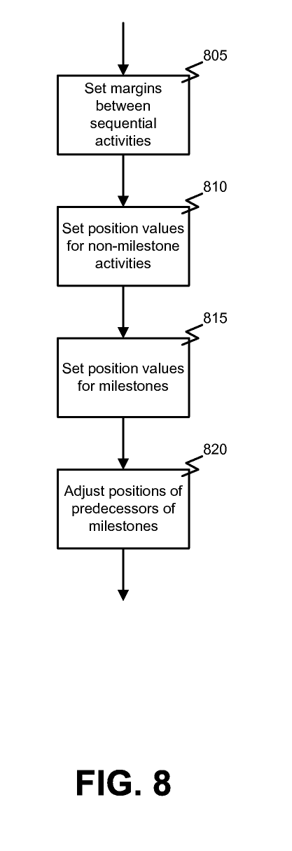

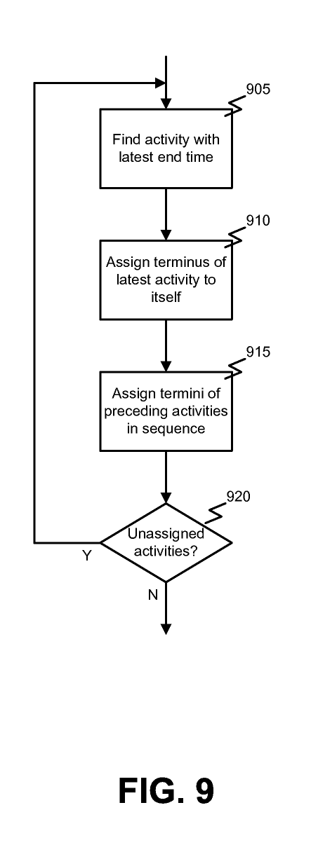

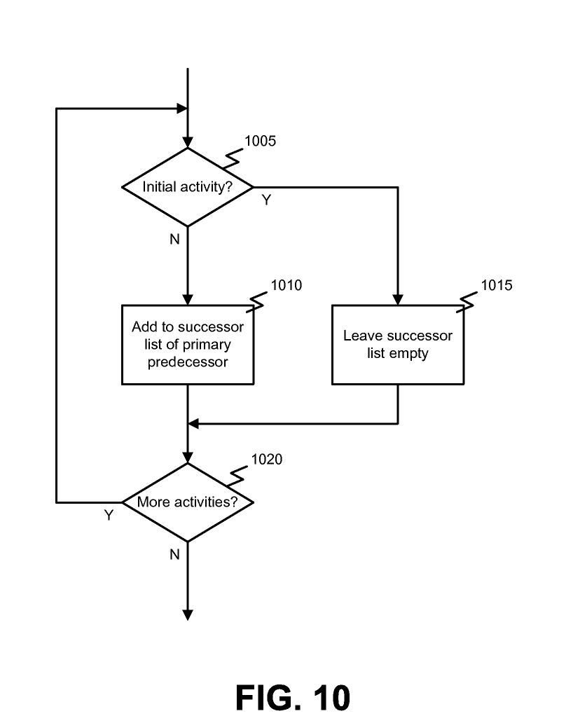

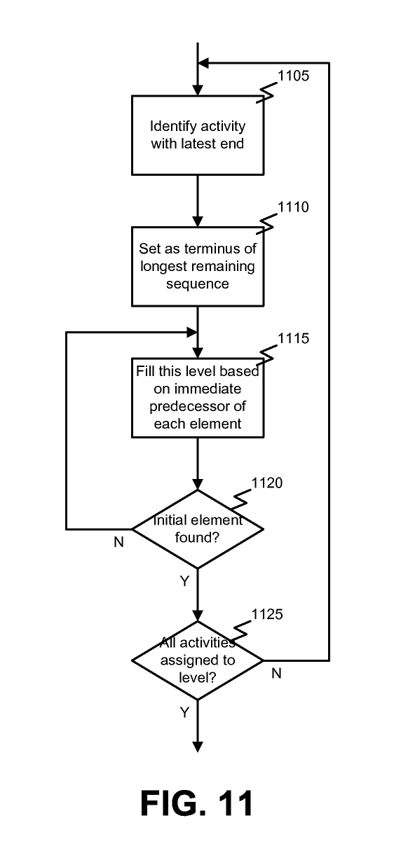

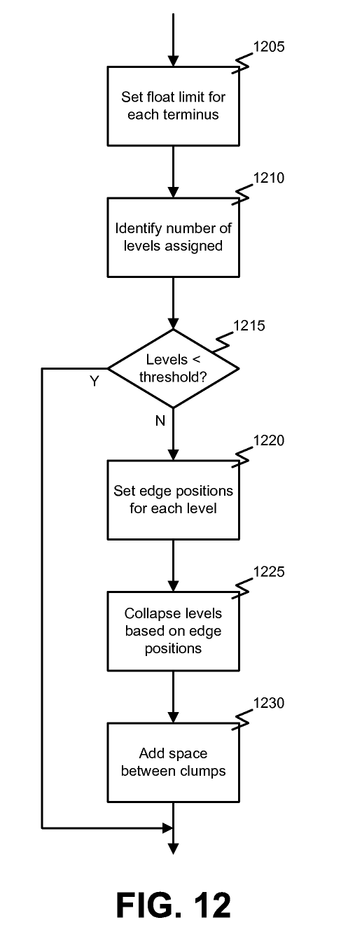

More specifically, generating one or more ordered lists of elements can comprise determining 510 for each element of the map and based on the description, a predecessor element, a start time, and an end time. Additional details of an example of such a process is described below with reference to FIG. 6. A flexible width can be determined 515 for each of a plurality of time periods. The plurality of time periods together can include or span the start times and end times of the elements of the map, i.e., represent the span of the project. An exemplary process for determining the time periods is described in greater detail below with reference to FIG. 7. Next, a position on the map and a width of a graphical representation of each element of the map can be determining 520 such as will be described in greater detail below with reference to FIG. 8. A terminus can be identified 525 for each element of the map. An exemplary process for identifying the termini will be described in greater detail below with reference to FIG. 9. Also as will be described in greater detail below, with reference to FIG. 10, one or more ordered lists of successor elements can be creating 530 based on the identified terminus of each element. Once the ordered lists have been created 530, a level within the map can be determined 535 for each of the one or more ordered lists. An exemplary process for doing so will be described in greater detail below with reference to FIG. 11. A float limit for each level can also be identified 540 as will be described with reference to FIG. 12. In some cases and also as described in greater detail with reference to FIG. 12, a first level within the map and a second level within the map may be collapsed 545 or combined into a single level if the first level and the second level do not overlap. Finally, the map can be drawn 550 based on the levels of ordered lists.

Generating the map can begin with identifying a primary predecessor. By identifying one predecessor among multiples, a tangled web of relationships between the activities and milestones of the project can be transformed into a series of distinct sequences that can then be arranged meaningfully in space. The primary predecessor can be defined as the predecessor with the latest end day. If the latest end day is shared by two or more predecessors, the one with the highest ID number can be selected.

A process for identifying predecessors can first identify the initial activities (activities with no predecessor) and sets them to start on day 1. It can then repeatedly scan and rescans the remaining activities, working outward from the initial activities. Once all the predecessors of a given activity have been assigned start and end days, that activity can be assigned its own primary predecessor, which in turn determines its own start and end days. This makes it possible to define assignments for succeeding activities. The process continues until all activities are accounted for. So for example, the map can begin on day 1 and start days of activities can be given as day numbers relative to that. End days can be set to start day+duration−1; one-day tasks start and end on the same day.

Milestones, i.e., 0-duration activities can be handled differently. Milestones can occur by themselves, or can form chains, the first dependent upon a preceding activity, the rest dependent on preceding milestones—all taking up space in the map but no time. To represent this, milestones can set both start and end days to the end day of their primary predecessor+0.1. For example, if an initial 3-day task was followed by a milestone, the milestone's start and end days can be set to 3.1. If another milestone was dependent on the first, and yet another on the second, the remaining milestones in the chain can be assigned start and end days of 3.2, 3.3, 3.4, etc.

To deal with hard-coded start dates, this algorithm can first determine the actual calendar date defined for day 1 of the project, use it to derive calendar dates from relative dates, and then increase the start date for any activity with a later hard-coded date. If a hard-coded date precedes a relative date based on dependencies, the dependencies can prevail, but a warning or exception can be shown to the user.

FIG. 6 is a flowchart illustrating a process for determining predecessors, start times, and end times for activities of a project according to one embodiment of the present invention. In this example, determining for each element of the map a predecessor element, a start time, and an end time can comprise creating 605 a table mapping an element identifier to a sequence number for each element of the map. A determination 610 can be made as to whether at least one starting element is represented in the table. In response to determining 610 at least one starting element is represented in the table, predecessor, start time and end time can be set for each starting element 615 and any elements other than starting elements 620.

Stated another way, an example of this process can be outlined as:
Create a lookup table to convert activity IDs into sequential activity numbers. (This lookup table can be used by the other processes as well.)
First Pass: Set values for starting activities
   For Plist lines with no predecessors:
      Primary predecessor--->0
      Start day--->1
      End day--->duration
   HALT if no starting activities found
Second Pass: Set values for remaining activities
   If all predecessors have defined end days:
      Set latest one as primary predecessor (PP)
      Set start day as PP+1
      Set end day as PP+duration
      If duration=0, set start and end days as PP+0.1
   If any predecessor end days still undefined, skip
   Repeat until all values have been assigned

Next, day widths in pixels can be determined, forming a flexible timeline. These calculations can be based on a set of predefined widths. For example, the predefined widths can be stored in a table such as:

TABLE 2

| | | Initial | Inner | Final | Total | Total |
|---|---|---|---|---|---|---|
| | Initial | Day | Day | Day | Box | Day |
| Duration | Days | Width | Width | Width | Width | Width |
| 1 | 0 | 0 | 0 | 25 | 20 | 25 |
| 2 | 0 | 0 | 12 | 17 | 24 | 29 |
| 3 | 1 | 10 | 9 | 14 | 28 | 33 |
| 4 | 1 | 8 | 8 | 13 | 32 | 37 |
| 5 | 1 | 8 | 7 | 12 | 36 | 41 |
| 6 | 2 | 8 | 6 | 11 | 40 | 45 |
| 7 | 2 | 7 | 6 | 11 | 44 | 49 |
| 8 | 2 | 6 | 6 | 11 | 48 | 53 |
| 9 | 3 | 6 | 6 | 9 | 52 | 57 |
| 10 | 3 | 7 | 5 | 10 | 56 | 61 |
| 11 | 3 | 7 | 5 | 9 | 60 | 65 |
| 12 | 4 | 6 | 5 | 10 | 64 | 69 |
| 13 | 4 | 6 | 5 | 9 | 68 | 73 |
| 14 | 4 | 5 | 5 | 12 | 72 | 77 |
| 15 | 5 | 5 | 5 | 11 | 76 | 81 |
| 16 | 5 | 5 | 5 | 10 | 80 | 85 |
| 17 | 5 | 5 | 5 | 9 | 84 | 89 |
| 18 | 6 | 6 | 4 | 13 | 88 | 93 |
| 19 | 6 | 6 | 4 | 13 | 92 | 97 |
| 20 | 6 | 6 | 4 | 13 | 96 | 101 |
| 21 | 6 | 6 | 4 | 13 | 100 | 105 |

Each day of each activity can be assigned a minimum width based on the activity's duration using the set of fixed values stored in the Widths field (shown above). In this example, the field has 18 lines. Durations greater than 18 can use line 18 of the field.

According to one embodiment, one-day activities can have a fixed width of 25 pixels. Longer activity widths can be determined by the sum 3 values: Initial day widths; Inner day widths; and Final day width. The total number of initial days can equal one third of the duration (rounded down). The final day can include a margin, e.g., 5 pixels at the end for the margin between boxes in a sequence. For example, an activity of seven days would use line 7 of the Widths field, which has values 7, 6, and 11. Since 7/3=2, this activity had two initial days, 4 inner days, and one final day. Therefore its total width is 7+7+6+6+6+6+11=49 pixels. The box itself would be 44 pixels wide, with 5 pixels of padding at the end.

The total effect of this formula can be to produce a minimum box width for one-day tasks which then increases by 4 pixels for each additional day of duration. The day widths spanning this activity can vary in size, with the final day being wider than the rest to provide room for inter-box margins.

Once the minimum day widths are calculated for each activity in the map, the final day widths for the overall map can be determined. Each day of the time scale can be set to the maximum width required for the activities active during that day. Overall box widths can widen by different amounts, but relative sizing can be maintained (boxes with bigger durations can be wider than boxes with smaller durations), and boxes starting on a given day can have the same x coordinate.

Once this is done, a second pass can expand days which contain milestones or milestone chains. The final results can be stored in the Days field, which can hold values for each day of the project such as: Day number, starting with 1; Day width in pixels; and Day's x coordinate starting at 0 for day 1.

FIG. 7 is a flowchart illustrating a process for determining widths of map elements according to one embodiment of the present invention. In this example, determining the flexible width for each of the plurality of time periods can comprise determining a width of each of a plurality of map elements 705. Each period can include one or more elements and determining 705 the width of each of the plurality of periods can be based on a duration of the activities in the period. The period width for any period including at least one milestone can then be expanded 710. A position in the map can be determined 715 for each of the plurality of periods based on a sum of period widths for periods prior to each period.
Stated another way, an example of this process can be outlined as:
   First pass—calculate day widths for each non-milestone activity:
   If duration=1, set day width and maximum day width to 25 pixels
   If duration>1:
      Look up initial, inner, and final day widths for the duration
      For each day of the activity:
         Determine if it's an initial, inner, or final day and get width
         If width>max width for that day, set max width to it
Second pass—expand days with milestones or milestone chains
   Find the maximum number of milestones present for each day
   If >0, add 27 additional pixels for each milestone needed
Calculate x coordinate for each day by summing previous widths

The previous two steps determine start and end days for each activity, and the width in pixels for each day in the flexible time scale. With these values, the starting x coordinate and pixel width for each activity box can be calculated. When determining the width of a box, the 5-pixel margin appended after every box in a sequence should be considered.

Milestone diamonds can be calculated separately. Since milestones (or possibly chains of milestones) can be appended to the final day of preceding activities, additional calculations can be used to calculate actual pixel width of those preceding activities.

These same adjustments can be made for the corner case of “parallel” activities that have the same starting position and duration as a milestone's primary predecessor. An example of this occurs for activities 67, 68, and 69 in the example map shown above in Table 1 and FIG. 4. Activity 69 is followed by milestone 75, making its end day longer than it normally would be. The same is true for activities 67 and 68, because they are triggered at the same time as 69 and happen also to be the same duration.

FIG. 8 is a flowchart illustrating a process for determining positions and widths of map elements according to one embodiment of the present invention. In this example, determining the position on the map and the width of the graphical representation of each element can comprises setting 805 margins between sequential elements to a predetermined amount. Position values for each activity can be set 810 based on start time, end time, and margin for each activity. Position values for each milestone can be set 815 based on start time and a predetermined milestone width. Positions of predecessor elements of milestones can be adjusted 820 based on the positions of the milestones and the predecessors.

Stated another way, an example of this process can be outlined as:
Margin, the space between sequential activities, set to 5 pixels
First pass—set values for most cases:
   finalx--->x of activity's ending day+width of ending day
   If duration=0 (milestone):
      chainpos--->position in possible chain of milestones
      chainwidth--->max number of milestones for this day
      startx--->finalx−(28*chainwidth)+(28*(chainpos−1))
      pixel width--->30 (standard with for milestone diamonds)
   If duration>0:
      startx--->x of activity's starting day from Days field
      pixel width--->finalx−x coordinate−margin
Second pass—adjust values for corner cases:
   For each milestone in the project:
      Reduce width of primary predecessor by 27*number of milestones immediately following it
      Make same reduction for other predecessors which are in the same position and duration of the primary predecessor

A “terminus” can be defined as the final activity in a sequence of activities. The termini of all sequences in a group can be performed so that parallel sequences can be arranged vertically according to sequence length. The longest (critical path) sequence can be drawn at the bottom of the group box, the next longest above that, and so on.

A process for finding the termini of map elements can find the last activity of the longest sequence and sets it as the terminus of all activities in that sequence. The process can then be repeated for the next longest sequence and continuing until all activities have a defined terminus. The final output can be a Termini field holding the terminating activity number and end day for each activity.

FIG. 9 is a flowchart illustrating a process for determining termini of map elements according to one embodiment of the present invention. In this example, identifying the terminus for each element can comprise identifying 905 an element with a latest end time. The element with the latest end time can be assigned 910 as a terminus of itself. A terminus of preceding elements in the same sequence can be assigned 915 based on the sequence. Identifying 905 an element with a latest end time, assigning 910 the element with the latest end time as a terminus of itself, and assigning 915 a terminus of preceding elements in the same sequence based on the sequence can be repeated until a determination 920 is made that all of the elements are assigned a terminus.

Stated another way, an example of this process can be outlined as:
Find the activity with the latest end date. This will be the terminus of the longest (critical path) sequence.
   Set terminus of that activity (to itself)
   Mark it as assigned
   Set the terminus of all preceding activities in that sequence:
      Find the last activity's primary predecessor
      Set its terminus and mark it as assigned
      Repeat until
      You reach an activity that already has a terminus (a branching point)
      You reach an initial activity
Search unassigned activities and find the latest end date. The activity with the latest end date will now become the terminus of the second-longest sequence.
   Repeat above procedure to set the terminus for all activities in that sequence
Keep repeating until every activity has a defined terminus.

At this point, predecessors for each activity have been identified. In order to draw branching lines to parallel sequences, each activity's successors can also be identified. When an activity has more than one successor, the successors can be ordered according to their termini, for example, with the successor at the head of the longest sequence branch coming first. Such an ordering can be used to causes the most critical paths to be drawn at the bottom of the map. According to one embodiment, if two branches have the same end day, the successor with the highest ID number can come first (closest to the bottom).

FIG. 10 is a flowchart illustrating a process for creating ordered lists of successors of map elements according to one embodiment of the present invention. In this example, creating the one or more ordered lists of successor elements can comprise determining 1005 whether an element is an initial element in a sequence. In response to determining 1005 the element is the initial element in the sequence, its successor list 1015 can remain empty. In response to determining 1010 the element is not the initial element in the sequence, the element can be added 1010 to the ordered list for the sequence based on the terminus of the element and the termini of other elements in the ordered list. Determining 1005 whether an element is an initial element in a sequence and setting 1015 the element as a sole element of the ordered list or adding 1010 the element to the ordered list for the sequence can be repeated until a determination 1020 is made that all elements are added to an ordered list.

Stated another way, an example of this process can be outlined as:
Repeat for each non-initial activity
   Add me to the successor list of my primary predecessor
If I am the first one found, just set me as the sole value
If others have already been found:
   Compare my terminus to the terminus of the others
   If my terminus is greatest put me at the front of the list
   If not, put me after the last item greater than me
Because loop runs in descending order, ties will be sorted with higher IDs first

A sequence level can be considered a sequence's vertical position within the map. For example, the bottommost position can be assigned level 1, the next highest level 2, etc. A process for determining sequence levels can determine initial levels based on sequence length (the longer the sequence, the lower its level). Adjustments to these levels can be made thereafter.

The process for determining sequence levels can find the terminus of the longest (critical path) sequence, set it to level 1, and call a recursive subroutine to start working backwards. When it hits a branching point a new level can be defined. The recursive subroutine can be called again for other sequences at that branching point. If those branches have branches of their own, more levels can be added. This process can be understood in view of the map 400 of FIG. 4. The process can start at activity 85 at the end of the critical path and work backward, assigning preceding activities to level 1. When it hits the branch at 74, the routine can set 83 to level 2 and work back. When it hits the sub-branch at 79, 72 can be set to level 3. When those recursions terminate, the original instance can pick up at 74 and keep working backward for additional level 1 activities. When it hits the branch at 73, activity 68 can be assigned to level 4 and activity 67 can be assigned to level 5. Because these two sequences are very short, they can eventually be pushed down or collapsed to conserve space as will be described.

FIG. 11 is a flowchart illustrating a process for determining sequence levels of map elements according to one embodiment of the present invention. In this example, determining the level within the map for each of the one or more ordered lists can comprise identifying 1105 an element with a latest end time. The identified element can be set 1110 as a terminus of a longest remaining sequence. Immediate predecessors can be added 1115 to the longest remaining sequence until a determination 1120 is made that an initial element is found. Identifying 1105 an element with a latest end time, setting 1110 the identified element as a terminus of a longest remaining sequence, and adding 1115 immediate predecessors to the longest remaining sequence until 1120 an initial element is found can then be repeated until a determination 1125 is made that all elements are assigned.

Stated another way, an example of this process can be outlined as:
Start with level 1
Find the latest end date of all activities without an assigned level. This will be the terminus of the longest remaining sequence
Call recursive routine “backfill”
   Set level of terminus and start working backward along sequence
   Set each activity found to current level
   If activity has multiple successors this is a branching point. For each sequence branching off:
      Find the terminus of that branch
      Call backfill with new, ever-higher level number
   Keep working backward until:
      you hit an activity that already has a level assigned
      you hit an initial activity
Outer loop will reach branches from the first initial activity. In case there is more than one initial activity, repeat until all activities have an assigned level.

Thus, separate levels have been assigned for each branch of each sequence in the group. In some cases, this can result in an unnecessarily tall map with much wasted space. Therefore, according to one embodiment, levels can be combined or collapsed whenever feasible and other adjustments can be made to produce a more compact and readable map.

For example, if no other activities depend on the final terminus activity of a given branched sequence, that activity can be free to float to the end of the group box and have a clear path (and thus its own separate level) to do so. But it often happens that the terminus of a branch will affect some later activity and so has a limit on how far it can float. These limits are shown in the map 400 of FIG. 4 as a dotted line 425 from the terminus to the x coordinate of the dependent activity. If such a branch is short, and if it's float limit is also short, it may not need to consume an entire level of its own. If there is enough of a margin over a predetermined minimum, e.g., 40 pixels, between the end of a float limit and the next branch rising up from the same parent sequence, that short branch can be pushed down and share a level with the later branch. As discussed above, the level assignment process initially assigns activities 68 and 67 of map 400 in FIG. 4 to levels 4 and 5 respectively. But both of these branches consist of a single activity followed by a very short float limit, leaving plenty of room before the branches starting with activities 77 and 70 pop up. The process for collapsing levels can discover cases like this and reduce the levels of the early, short branches, and thus the overall number of levels used in the map.

According to one embodiment, branches in the map can be drawn at a predetermined height, e.g., 30 vertical pixels, per level for a consistent margin, e.g., 10 pixels between levels. This margin can be used to making the map more readable. But, branches can occur in clumps, bordered at points where the longest branch of one clump extends leftward over the smallest branch of the clump just below it. When levels are equally spaced it becomes harder to tell one clump from the next. To increase readability in these situations, the process can raise the long branch and levels above it by half a level (e.g., 15 pixels), creating an additional margin (e.g., 25 pixels) between clumps. The overall effect of this is to visibly partition related sets of branches, making the overall pattern easier to discern. In the example map 400 of FIG. 4, three such half-level gaps were added to demarcate four clumps: the 3-level sequence on the bottom, the cascade of branches extending from activity 97, the five short peer branches above 97, and the initial branching sequence on the top starting with activity 61.

FIG. 12 is a flowchart illustrating a process for determining float limits and collapse levels of map elements according to one embodiment of the present invention. In this example, identifying the float limit for each level comprises setting 1205 a float limit for a terminus of each ordered list based on an earliest start time for a predecessor element in the ordered list. A number of levels assigned can be identified 1210 based on a number of ordered lists. A determination 1215 can be made as to whether the number of levels exceeds a predetermined threshold, i.e., it may not be worth considering further if only a few level are present. In response to determining 1215 the number of levels exceeds the predetermined threshold, edge positions can be set 1220 for each level, a first level within the map and a second level within the map can be collapsed 1225 if the float limit for the first level is less than a start time of an initial element of the second level and a predetermined margin, and a space between levels can be adjusted 1230.

Stated another way, an example of this process can be outlined as:
First pass—for each terminus:
   Find activities which depend on this terminus
   If one or more is found, set the “deadline” (float limit) of that terminus to the earliest start day of a dependent activity
   Store this value in the Float field
Find the number of levels assigned
   If less than 3, exit: map is too simple to need further adjustments
Second pass—Find leftmost and rightmost position for each level
   Find the starting x coordinate of each activity box
      If it is less than the least value so far for that activity's level, set it as the leftmost position for that level
   If the activity is a terminus with a float limit:
      Get the float limit day from the Float field
      Look up the ending x coordinate for that day in the Days field
      Set it as the rightmost position for that level
Third pass—examine candidate levels starting with level 3
   If level doesn't end with a trailing float limit, try next level
   If rightmost position plus margin less then leftmost of preceding level:
      If we're higher than level 3 check to see if we can drop more than one level
         Test if lower levels are also with the margin
         newlow--->lowest possible level
      Set all activities at candidate level to newlow
      Subtract 1 from level of all activities above candidate level
      Reset leftmost position of now-shared candidate level
      Move all higher lines in Levels table down by one (collapse total number of levels by one)
   Repeat until the topmost level has been examined
Fourth pass—Add breathing room between clumps
   Examine levels from the top down
      If leftmost position of level less than level below it
         Add 0.5 to level number of this level and every level above it
   Repeat down to level 3

At this point, the values to define each element of the map have been determined and the map can be drawn. To draw the map, the origin (e.g., location 0,0) can be located. For example, the origin may be in the upper left corner as it is on the iPad. In such a case and for illustrative purposes here, the map can then be drawn from a lower left corner positioned at coordinates (20,520). The process for drawing the map can begin by drawing a representation of the flexible timeline below the map. The activity boxes and milestone diamonds can then be drawn using x positions from the Xpos field and y positions derived from the Levels field. Activity IDs can be typed in to serve as labels. Next, float limit lines can be drawn if any are present. A small adjustment can be made for float lines governed by a milestone or milestone chain. In some cases a terminus cannot float. If this happens a short vertical bar can be drawn to the right of the terminus instead of a dotted arrow. Finally, dependency arrows can be drawn from all activities with branching successors.

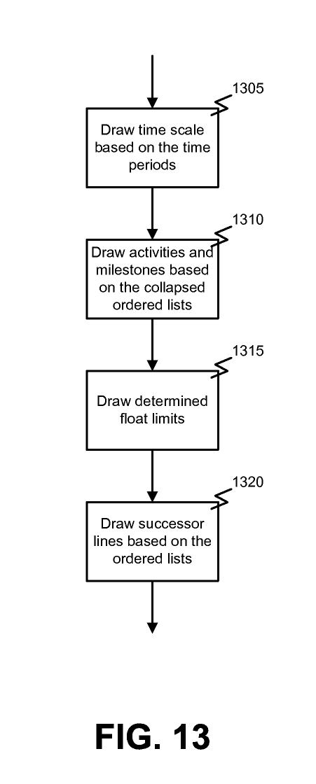

FIG. 13 is a flowchart illustrating a process for drawing a project map according to one embodiment of the present invention. In this example, drawing the map can comprise drawing 1305 a time scale based on the plurality of time periods, drawing 1310 the elements based on the ordered lists, drawing 1315 the determined float limits based on the time scale, and drawing 1320 successor lines between the elements based on the ordered lists. Stated another way, an example of this process can be outlined as:
First pass—Draw flexible time scale:
   Starting at (20,595) draw a 20-pixel-high box the width of the first day
   Add that width to define the starting point for the next day
   Repeat for all days in the timeline
Second pass part 1—Draw activity boxes and milestone diamonds:
   Find bounding coordinates (x1,y1) to (x2, y2) from the appropriate fields
   For milestone diamonds:
      Adjust offsets to type label in center of diamond
      Draw the four lines of the 24×24 diamond
   For activity boxes:
      Draw box from (x1,y1) to (x2,y2)
      Adjust offset to type label in center of box
Second pass part 2—Draw float limit lines (if needed)
   Determine x coordinate for the end of the float line
   Adjust if float line leads to a milestone
      Add 28 pixels per position within a possible milestone chain
   If the limit is not immediate:
      Draw a dotted line
      Draw an arrow on the end
   If immediate, draw a short vertical bar just right of the terminus
Second pass part 3—Draw successor lines (if needed)
   If activity has less than two successors, skip: there is no branching
   Determine coordinates for start of link line
      For milestones start above the tip of the diamond
      For activities start 10 pixels left of the boxes upper right corner
   Draw vertical portion of line up to highest successor branch
   For each successor branch:
      Draw horizontal line and arrow at appropriate level

FIG. 14 is a representation of an exemplary user interface for a project map according to one embodiment of the present invention. As noted above, the project mapper and the processes for generating and drawing or rendering the project map as described herein can be implemented on a client device that reads project description information from server or other computing system. For example, the client device can comprise a tablet, cell phone, or other mobile device executing an app for performing the processes of the project mapper. The example of FIG. 14 illustrates a user interface rendered by such an app according to one embodiment.

The map 1400 can include a timeline 1405 spanning the duration of the project, or the portion of the project represented in the map 400. Activities 1410 can be represented as boxes or rectangles of varying widths depending upon or related to the duration of the particular activity 1410 or groups 1415 of activities. The project map 1400 as illustrated here can be fully two dimensional in that group width, i.e., the width of a set of activities and milestones, can show length of critical paths and group height can show amounts of concurrent activity. Sequential activities can be arranged sequentially and connected by successor lines 1420 in a way that clarifies both critical and the sub-critical paths harder to see using earlier methods. Activities 1410 and milestones represented in the map 1400 can be nested in any of a number of levels and used as a canvas to overlay additional analytics like progress and resource allocation (not shown here for the sake of simplicity and clarity).

This map 1400 can be rendered as a touchable, zoomable, interactive representation for display. A viewer interface for presenting the map 1400 can allow panning, zooming, and drilling to sub-maps, i.e., groups 1415 of activities in an intuitive way. The full project timeline 1405 and moving reference box 1430 can be used to prevent users from becoming disoriented as they explore a large project. Additional information can be displayed as map elements become larger during zooming. Multiple modes, including a progress mode and a resources mode can provide additional information displays against the context of the map. A pullout list 1425 and project inspector can provide lists of options for additional features such as searching and filtering.

According to one embodiment, a Work Breakdown Structure (WBS) can define a hierarchical set of activities arranged in a potentially nested set of groups. Activities can be represented as rectangles with single-line borders, and a group of activities can be represented as a rectangle with double-line borders enclosing those activities. A subgroup within a group can be represented as a collapsed group 1435, e.g., a rectangle with double-line borders holding the name of the subgroup. When the user opens a collapsed group 1435 in the interactive map 1400 (e.g., by double-tapping or using some other gesture or input), the larger map 1400 can be replaced with an expanded map of that subgroup. This process can be repeated indefinitely as needed. The process of opening a collapsed subgroup is referred to as drilling. Drilling is different than zooming which enlarges the current maps, possibly exposing more details within each activity box.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. A method for providing a graphical, interactive map representing a project, the method comprising:
reading a description of the project, the description defining a plurality of activities in the project and one or more milestones for the project, wherein the plurality of activities and one or more milestones comprise elements of the map;
generating one or more ordered lists of elements based on the description, the one or more ordered lists arranged in one or more levels; and
drawing the map based on the levels of ordered lists.

2. The method of claim 1, wherein generating one or more ordered lists of elements comprises:
determining for each element of the map and based on the description, a predecessor element, a start time, and an end time;
determining a flexible width for each of a plurality of time periods, the plurality of time periods together including the start times and end times of the elements of the map;
determining a position on the map and a width of a graphical representation of each element of the map;
identifying a terminus for each element of the map;
creating one or more ordered lists of successor elements based on the identified terminus of each element;
determining a level within the map for each of the one or more ordered lists;
identifying a float limit for each level.

3. The method of claim 2, further comprising collapsing a first level within the map and a second level within the map if the first level and the second level do not overlap.

4. The method of claim 2, wherein determining for each element of the map a predecessor element, a start time, and an end time comprises:
creating a table mapping an element identifier to a sequence number for each element of the map;
determining whether at least one starting element is represented in the table; and
in response to determining at least one starting element is represented in the table, setting predecessor, start time and end time for each starting element and any elements other than starting elements.

5. The method of claim 2, wherein determining the flexible width for each of the plurality of time periods comprises:
determining a width of each of a plurality of periods, each period including one or more elements, wherein determining the width of each of the plurality of periods is based on a duration of the activities in the period;
expanding the period width for any period including at least one milestone; and
determining a position in the map for each of the plurality of periods based on a sum of period widths for periods prior to each period.

6. The method of claim 2, wherein determining the position on the map and the width of the graphical representation of each element comprises:
setting margins between sequential elements to a predetermined amount;
setting position values for each activity based on start time, end time, and margin for each activity;
setting position values for each milestone based on start time and a predetermined milestone width; and
adjusting positions of predecessor elements of milestones based on the positions of the milestones and the predecessors.

7. The method of claim 2, wherein identifying the terminus for each element comprises:
identifying an element with a latest end time;
assigning the element with the latest end time as a terminus of itself;
assigning a terminus of preceding elements in the same sequence based on the sequence; and
repeating identifying an element with a latest end time, assigning the element with the latest end time as a terminus of itself, and assigning a terminus of preceding elements in the same sequence based on the sequence until all of the elements are assigned a terminus.

8. The method of claim 2, wherein creating the one or more ordered lists of successor elements comprises:
determining whether an element is an initial element in a sequence;
in response to determining the element is the initial element in the sequence, leaving the successor list empty;
in response to determining the element is not the initial element in the sequence, adding the element to the ordered list for the sequence based on the terminus of the element and the termini of other elements in the ordered list; and
repeating determining whether an element is an initial element in a sequence and leaving the successor list empty or adding the element to the ordered list for the sequence until all elements are added to an ordered list.

9. The method of claim 2, wherein determining the level within the map for each of the one or more ordered lists comprises:
identifying an element with a latest end time;
setting the identified element as a terminus of a longest remaining sequence;
adding immediate predecessors to the longest remaining sequence until an initial element is found; and
repeating identifying an element with a latest end time, setting the identified element as a terminus of a longest remaining sequence, and adding immediate predecessors to the longest remaining sequence until an initial element is found until all elements are assigned.

10. The method of claim 2, wherein identifying the float limit for each level comprises:
setting a float limit for a terminus of each ordered list based on an earliest start time for a predecessor element in the ordered list;
identifying a number of levels assigned based on a number of ordered lists;
determining whether the number of levels exceeds a predetermined threshold; and
in response to determining the number of levels exceeds the predetermined threshold, setting edge positions for each level, collapsing a first level within the map and a second level within the map if the map if the float limit for the first level is less than a start time of an initial element of the second level and a predetermined margin, and adjusting a space between levels.

11. The method of claim 2, wherein drawing the map comprises:
drawing a time scale based on the plurality of time periods;
drawing the elements based on the ordered lists;
drawing the determined float limits based on the time scale; and
drawing successor lines between the elements based on the ordered lists.

12. A computer-readable memory having stored thereon a sequence of instructions which, when executed by a processor, causes the processor to provide a graphical, interactive map representing a project by:
reading a description of the project, the description defining a plurality of activities in the project and one or more milestones for the project, wherein the plurality of activities and one or more milestones comprise elements of the map;
determining for each element of the map and based on the description, a predecessor element, a start time, and an end time;
determining a flexible width for each of a plurality of time periods, the plurality of time periods together including the start times and end times of the elements of the map;
determining a position on the map and a width of a graphical representation of each element of the map;
identifying a terminus for each element of the map;
creating one or more ordered lists of successor elements based on the identified terminus of each element;
determining a level within the map for each of the one or more ordered lists;
identifying a float limit for each level;
collapsing a first level within the map and a second level within the map if the first level and the second level do not overlap; and
drawing the map based on the levels of ordered lists.

13. The computer-readable memory of claim 12, wherein determining for each element of the map a predecessor element, a start time, and an end time comprises:
creating a table mapping an element identifier to a sequence number for each element of the map;
determining whether at least one starting element is represented in the table; and
in response to determining at least one starting element is represented in the table, setting predecessor, start time and end time for each starting element and any elements other than starting elements.

14. The computer-readable memory of claim 12, wherein determining the flexible width for each of the plurality of time periods comprises:
determining a width of each of a plurality of periods, each period including one or more elements, wherein determining the width of each of the plurality of periods is based on a duration of the activities in the period;
expanding the period width for any period including at least one milestone; and
determining a position in the map for each of the plurality of periods based on a sum of period widths for periods prior to each period.

15. The computer-readable memory of claim 12, wherein determining the position on the map and the width of the graphical representation of each element comprises:
setting margins between sequential elements to a predetermined amount;
setting position values for each activity based on start time, end time, and margin for each activity;
setting position values for each milestone based on start time and a predetermined milestone width; and
adjusting positions of predecessor elements of milestones based on the positions of the milestones and the predecessors.

16. The computer-readable memory of claim 12, wherein identifying the terminus for each element comprises:
identifying an element with a latest end time;
assigning the element with the latest end time as a terminus of itself;
assigning a terminus of preceding elements in the same sequence based on the sequence; and
repeating identifying an element with a latest end time, assigning the element with the latest end time as a terminus of itself, and assigning a terminus of preceding elements in the same sequence based on the sequence until all of the elements are assigned a terminus.

17. The computer-readable memory of claim 12, wherein creating the one or more ordered lists of successor elements comprises:
determining whether an element is an initial element in a sequence;
in response to determining the element is the initial element in the sequence, leaving the successor list empty;
in response to determining the element is not the initial element in the sequence, adding the element to the ordered list for the sequence based on the terminus of the element and the termini of other elements in the ordered list; and
repeating determining whether an element is an initial element in a sequence and leaving the successor list empty or adding the element to the ordered list for the sequence until all elements are added to an ordered list.

18. The computer-readable memory of claim 12, wherein determining the level within the map for each of the one or more ordered lists comprises:
identifying an element with a latest end time;
setting the identified element as a terminus of a longest remaining sequence;
adding immediate predecessors to the longest remaining sequence until an initial element is found; and
repeating identifying an element with a latest end time, setting the identified element as a terminus of a longest remaining sequence, and adding immediate predecessors to the longest remaining sequence until an initial element is found until all elements are assigned.

19. The computer-readable memory of claim 12, wherein identifying the float limit for each level comprises:
setting a float limit for a terminus of each ordered list based on an earliest start time for a predecessor element in the ordered list;
identifying a number of levels assigned based on a number of ordered lists;
determining whether the number of levels exceeds a predetermined threshold; and
in response to determining the number of levels exceeds the predetermined threshold, setting edge positions for each level, collapsing a first level within the map and a second level within the map if the map if the float limit for the first level is less than a start time of an initial element of the second level and a predetermined margin, and adjusting a space between levels.

20. A system comprising:
a processor; and
a memory communicatively coupled with and readable by the processor and having stored therein a sequence of instructions which, when executed by the processor, cause the processor to provide a graphical, interactive map representing a project by reading a description of the project, the description defining a plurality of activities in the project and one or more milestones for the project, wherein the plurality of activities and one or more milestones comprise elements of the map, generating one or more ordered lists of elements based on the description, the one or more ordered lists arranged in one or more levels, and drawing the map based on the levels of ordered lists.
